(19) United States
(12) Patent Application Publication
(10) Pub. No.: US 2015/0111583 A1
(43) Pub. Date: Apr. 23, 2015

(54) COMMUNICATING DETECTION OF CONTROLLED RADIO FREQUENCIES

(71) Applicant: QUALCOMM Incorporated, San Diego, CA (US)

(72) Inventors: Purva Rameshchandra Rajkotia, Orlando, FL (US); Hassan Kaywan Afkhami, Ocala, FL (US); Deniz Rende, Gainesville, FL (US)

(73) Assignee: QUALCOMM Incorporated, San Diego, CA (US)

(21) Appl. No.: 14/058,368

(22) Filed: Oct. 21, 2013

(51) Int. Cl. H04W 16/10; H04B 3/54; H04W 52/24

(52) U.S. Cl. CPC H04W 16/10; H04W 52/243; H04B 3/54
USPC 455/447

(57) ABSTRACT

A radio detector may detect the presence of safeguarded radio frequency signals and one or more devices associated with a first network regarding the presence of the safeguarded radio frequency signals. The radio detector may be implemented as part of a device coupled to the first network, an accessory, a stand-alone detector, or as part of an infrastructure component. The radio detector may transmit a message regarding the detection of safeguarded radio frequency signals using any variety of messages, including a tone map, amplitude map, beacon message, host communication, tone mask, or the like.

### BACKGROUND

Embodiments of this disclosure generally relate to the field of network communications, and, more particularly, to coordinating information about detected radio frequencies among devices coupled to a network.

Communication technology is evolving to utilize multi-frequency transmissions over a communications medium. For example, in many technologies, such as powerline communications, a transmitting device may send signals via a plurality of frequencies to one or more other devices coupled to the communications medium. Other medium and technologies may also use multi-carrier transmissions in which multiple frequencies are used over a communication channel. The use of Orthogonal Frequency Division Multiplexing (OFDM) and other multi-frequency physical transmission technologies has greatly increased the capacity and reuse of frequencies.

With radio frequency transmissions, there remains a potential for interference at particular frequencies. Regulatory requirements may impose limits on the maximum radiated emissions for particular frequencies. For example, a set of frequencies may be allocated by a regulatory agency for use with a particular communications technology. The regulatory agency may set transmission power limits, may identify reserved frequencies within the set of frequencies, or may mandate adaptive power levels based on detected interference. The regulatory requirements may be for public health, frequency reuse, or other purposes. More recently, regulatory requirements have allowed for reuse of some controlled frequencies as long as a first network refrains from transmitting (or reduces power) at the controlled frequencies during times that a second network uses the controlled frequencies.

### SUMMARY

Various embodiments are described for detection and/or messaging regarding the presence of detected radio frequency signals at controlled frequencies. A radio detector may detect the presence of a safeguarded radio frequency signal having at least one controlled frequency. The radio detector may transmit a message to a first device associated with a first network regarding the presence of the safeguarded radio frequency signal. The radio detector may be implemented as part of a device coupled to the first network, an accessory, a stand-alone detector, or as part of an infrastructure component. The radio detector may transmit a message regarding the detection of safeguarded radio frequency signal using any variety of messages, including a tone map, amplitude map, beacon message, host communication, tone mask, or the like.

In one embodiment, a radio detector may detect a radio frequency signal having at least one controlled frequency associated with a first network. The radio detector may transmit a message from the radio detector to a first device of the first network to cause the first device to reduce power for the controlled frequency due to a presence of the safeguarded radio frequency signal.

### BRIEF DESCRIPTION OF THE DRAWINGS

The present embodiments may be better understood, and numerous objects, features, and advantages made apparent to those skilled in the art by referencing the accompanying drawings.

FIG. 1 depicts an example system including a radio detector communicatively coupled to a first network in accordance with an embodiment of this disclosure.

FIG. 2 depicts a flow diagram showing example operations of a radio detector in accordance with an embodiment of this disclosure.

FIG. 3 depicts an example system including a radio detector communicatively coupled via a host device in accordance with an embodiment of this disclosure.

FIG. 4 depicts an example system including a radio detector communicatively coupled via a powerline communications system in accordance with an embodiment of this disclosure.

FIG. 5 depicts an example message format for causing a first device to reduce power for a controlled frequency detected by the radio detector in accordance with an embodiment of this disclosure.

FIG. 6 depicts a flow diagram showing example operations of a radio detector in accordance with an embodiment of this disclosure.

FIG. 7 depicts an electronic device with a radio detector in accordance with various embodiments of this disclosure.

### DESCRIPTION OF EMBODIMENT(S)

The description that follows includes exemplary systems, methods, techniques, instruction sequences and computer program products that embody techniques of the present disclosure. However, it is understood that the described embodiments may be practiced without these specific details. For instance, although examples refer to particular message formats, information regarding detected frequencies may be communicated in a variety of messages. Various fields or portions of messages described herein may be omitted in some embodiments. In other instances, well-known instruction instances, protocols, structures and techniques have not been shown in detail in order not to obfuscate the description.

In accordance with various embodiments of this disclosure, a radio detector may detect for one or more safeguarded radio frequency signals associated with a controlled frequency. Controlled frequencies may include frequencies that are regulated by a government agency, specified by a standards setting body, configured by a network administrator, or selected by a network node based on user input or other activity. A frequency may be considered a controlled frequency to protect a safeguarded radio frequency signal from interference by devices of the first network using the same frequency. Devices associated with a first network are expected to reduce or eliminate transmit power (transmitted from the device) for the controlled frequency when a safeguarded radio frequency signal is using the controlled frequency. Some controlled frequencies may be reserved or allocated by regulatory bodies to prevent overlapping use by multiple networks. Regulatory bodies may require devices coupled to a communication network to limit transmissions at controlled frequencies when the presence of a safeguarded radio frequency signal is detected. A safeguarded radio frequency signal typically originates from a second network, different from the first network, and may use a different communication technology than the first network.

In some regions, two or more communications technologies may use similar frequencies. Limiting transmission power for particular frequencies may enable the two or more networks to utilize the same frequency allocations without causing unreasonable interference with one another. As an example, a powerline communications network may utilize a frequency band ranging from 2-30 MHz. Meanwhile, another network or technology may use particular frequencies that overlap with the powerline frequency band. Currently, in North America, there are approximately 10 controlled frequency ranges (i.e., reserved frequency ranges) that share the 2-30 MHz band otherwise associated with powerline communications. Therefore, a powerline communications device may be configured to reduce the transmit power for the controlled frequency sub-bands in the event that there is a safeguarded radio frequency transmission in the controlled frequency sub-bands. It should be understood that other reserved frequencies may be defined based upon shortwave radio interference, amateur radio transmissions, or other overlapping uses of particular frequencies.

Dynamic frequency exclusion refers to a technique by which a receiver device detects the presence of radio frequency signal and reduces transmit power for frequencies on which the detected signal is detected. For example, a dynamic frequency exclusion feature (also referred to as dynamic notching) may cause a powerline communications device to limit transmission power for certain frequencies or frequency ranges upon detecting a safeguarded radio frequency transmission from another source. Returning to the example of the powerline network, whenever a powerline communications device detects a safeguarded radio frequency transmission at a controlled frequency (or sub-band) from a communication system that is different from the powerline network, the powerline communications device may reduce power for the frequencies. Reducing power for particular frequencies may also be referred to as “notching” or “filtering.” In some communications medium, certain frequencies are required to be notched, and may be referred to as notched, reserved, or rejection bands.

Some devices, particularly legacy devices, may not have the hardware capable of detecting a safeguarded radio frequency signal. In this disclosure, a radio detector associated with a first network may detect for the presence of a safeguarded radio frequency signal and communicate the presence of the safeguarded radio frequency signal. In some implementations, the radio detector may be placed in proximity to the first network. The radio detector may be part of a first device of the first network. Alternatively, the radio detector may be an accessory to a computer that is communicatively coupled to the first network. Alternatively, the radio detector may be implemented as part of a network infrastructure. For example, a radio detector may be placed in a neighborhood of homes and communicate via a powerline network to indicate the presence of a safeguarded radio frequency signal. The radio detector may detect the presence of safeguarded radio frequency signals through a wired or wireless communication medium.

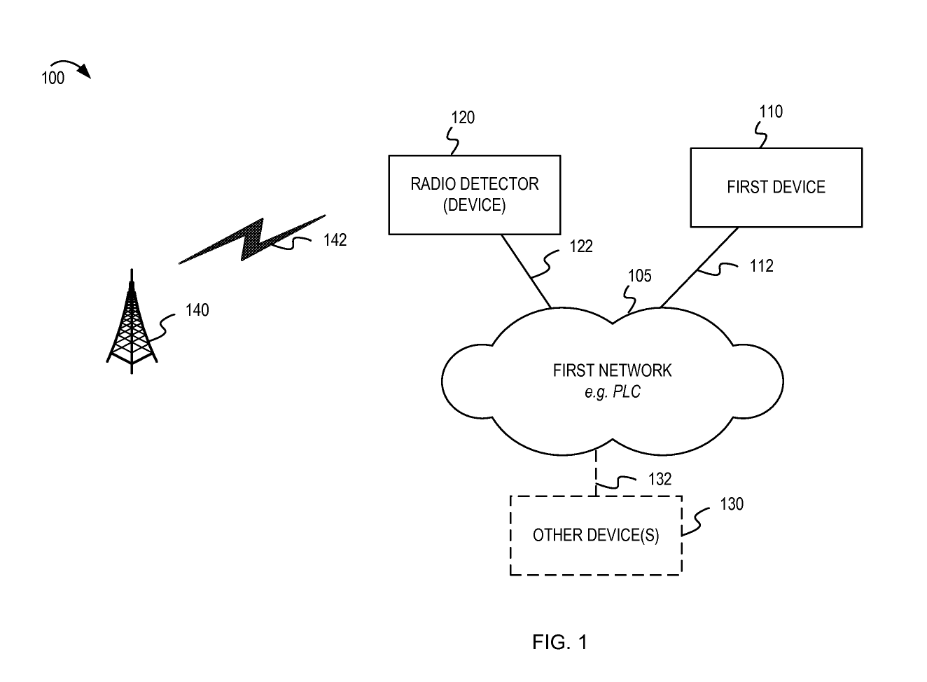

FIG. 1 depicts an example system 100 including a radio detector 120 communicatively coupled to a first network 105. The first network 105 may be a wired network, such as a powerline communications (PLC) network, Ethernet, coax, digital subscriber line (DSL), or the like. A first device 110 is communicatively coupled (shown as communications link 112) to the first network 105. A radio detector 120 is also communicatively coupled (shown as communications link 122) to the first network 105. It should be understood that the first network 105 may include a plurality of devices. FIG. 1 depicts other device(s) 130 communicatively coupled (shown as communications link 132) which may communicate via the first network 105 with the first device 110 or the radio detector 120.

Radio detector 120 is suitable for detecting the presence of a safeguarded radio frequency signal (shown as radio frequency signal 142) originating from a different network or safeguarded RF source 140. For example, safeguarded RF source 140 may be a terrestrial radio station. Alternatively, the safeguarded RF source 140 may be a satellite communications device. In one example, used in this description, the safeguarded RF source 140 may be a shortwave radio frequency device. The radio detector 120 is configured to detect the presence of the radio frequency signal 142 and determine if the radio frequency signal 142 includes a controlled frequency.

The radio detector 120 may include components (described in further detail below), such as an antenna, a receiver, and communication unit. In one example, a simple radio detector maybe constructed with an antenna and analog circuitry to discern the presence/absence of a controlled frequency signal. In other examples, a radio detector may include circuitry with digital logic. For example, a more advanced radio detector may detect an exact controlled frequency (out of several monitored frequencies) and thus enable selective notching of a particular frequency band. The radio detector 120 may be configured to scan a list of controlled frequencies to measure the signal level for each controlled frequency (or sub-band of frequencies).

The detection of the radio frequency signal may be based on measurement of the signal level (e.g., power or received signal strength) detected on the controlled frequency. In some embodiments, the radio detector 120 may be configured to compare signal strength of the radio frequency signal with a threshold to determine whether the radio frequency signal 142 includes at least one controlled frequency associated with the first network 105.

If the signal strength of the radio frequency signal 142 exceeds the threshold, the radio detector 120 may be configured to notify one or more devices of the first network 105 regarding the presence of radio frequency signal 142. Information regarding the frequency or frequencies of the safeguarded radio frequency signal 142 may be transmitted in a message to the first device 110. In one embodiment, the message could be sent directly to the first device 110 using a communication media of the first network 105. In another embodiment, the message may be transmitted via an out-of-band communication medium (not shown). This disclosure provides several examples of message types and formats that may be used to cause the first device 110 to notch the controlled frequency responsive to the radio detector 120 detecting the presence of the safeguarded radio frequency signal 142 having the controlled frequency. In one embodiment, the radio detector 120 may transmit a broadcast message (such as a beacon message) so that the first device 110 and other device(s) 130 may be notified regarding the presence of the safeguarded radio frequency signal 142. The message transmitted to the first device 110 may cause the first device 110 to reduce or eliminate transmit power for transmissions from the first device 110 at the controlled frequency. For example, if the first device 110 is transmitting a multi-carrier signal, the message from the radio detector 120 may cause the first device 110 to reduce power for the carrier associated with the controlled frequency.

In some implementations, the radio detector 120 may be a component or accessory of a device coupled to the first network 105. In another implementation, the radio detector 120 may be embedded in a powerline communications device (such as a PLC modem) coupled to the first network 105. Alternatively, the radio detector 120 may be communicatively coupled via a host device that relays the message to the first device 110.

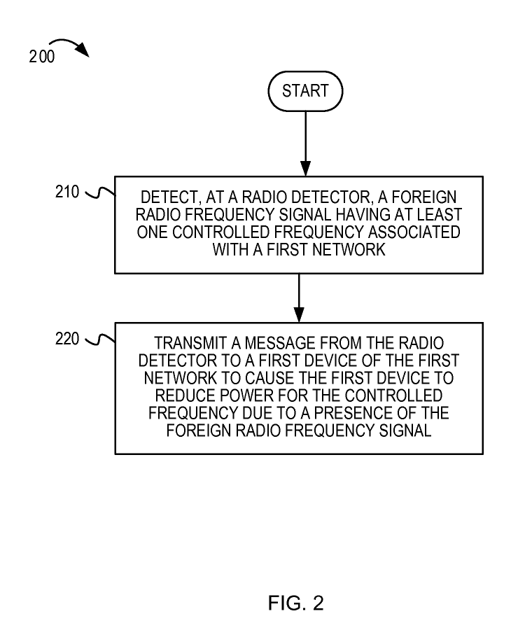

FIG. 2 depicts example operations 200 of a radio detector in accordance with an embodiment of this disclosure. At block 210, a radio detector may detect a safeguarded radio frequency signal having at least one controlled frequency associated with a first network. At block 220, the radio detector may transmit a message from the radio detector to a first device of the first network to cause the first device to reduce power for the controlled frequency due to a presence of the safeguarded radio frequency signal.

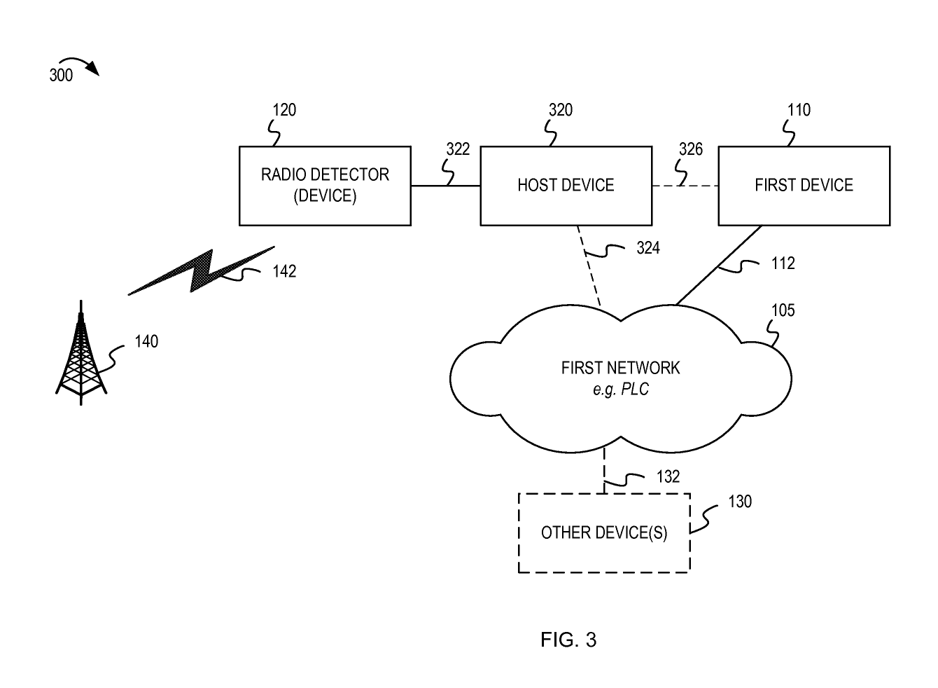

FIG. 3 depicts an example system 300 including a radio detector 120 communicatively coupled (shown as communications link 322) to a host device 320 in accordance with an embodiment of this disclosure. The radio detector 120 may include a host device interface (not shown) that is associated with a corresponding interface of the host device 320.

The host device 320 may be communicatively coupled (shown as communications link 324) to the first network 105. For example, the host device may have a network interface (not shown) that communicatively couples (shown as communication link 324) the host device 320 to the first network 105. The host device 320 may be capable of sending messages to the first device 110 via the first network 105. Therefore, the radio detector 120 may be capable of sending a message via the host device 320 through the first network 105 to other devices coupled to the first network 105 (such as the first device 110).

Alternatively, the host device 320 may be communicatively coupled (shown as communications link 326) directly (or using a different network, not shown) to the first device 110. The host device 320 may be capable of sending messages to the first device 110 via the communications link 326. Therefore, the radio detector 120 may be capable of sending a message via the host device 320 and communications link 326 to the first device 110. In one example, the radio detector 120 may be an accessory to a host device 320 with device manager capabilities. The host device 320 may control the first device 110 using a configuration/messaging protocol.

In one embodiment, the host device 320 may be a computer with an electrical interface capable of coupling the radio detector 120 as an accessory. For example, the radio detector 120 may be coupled to the computer using a USB, Bluetooth, or other coupling. The host device 320 may be capable of sending messages about the detected safeguarded radio frequency signal 142 to the first device 110 via the first network 105 or via the communications link 326 with the first device 110. The radio detector 120 may transmit a message via the host device 320 to a central controller or other network device of the first network 105. In another embodiment, once the radio detector 120 has detected a safeguarded radio frequency signal 142 having a controlled frequency, the host device 320 may send a message to a plurality of powerline devices in the household, neighborhood, or region. The message may indicate presence of the safeguarded radio frequency signal and may be associated with causing the devices coupled to the first network 105 to perform notching to reduce or eliminate power on the first network 105 for the controlled frequency associated with the safeguarded radio frequency signal. The first device 110, upon receiving the message indicating presence of the safeguarded radio frequency signal, may perform notching for the controlled frequency.

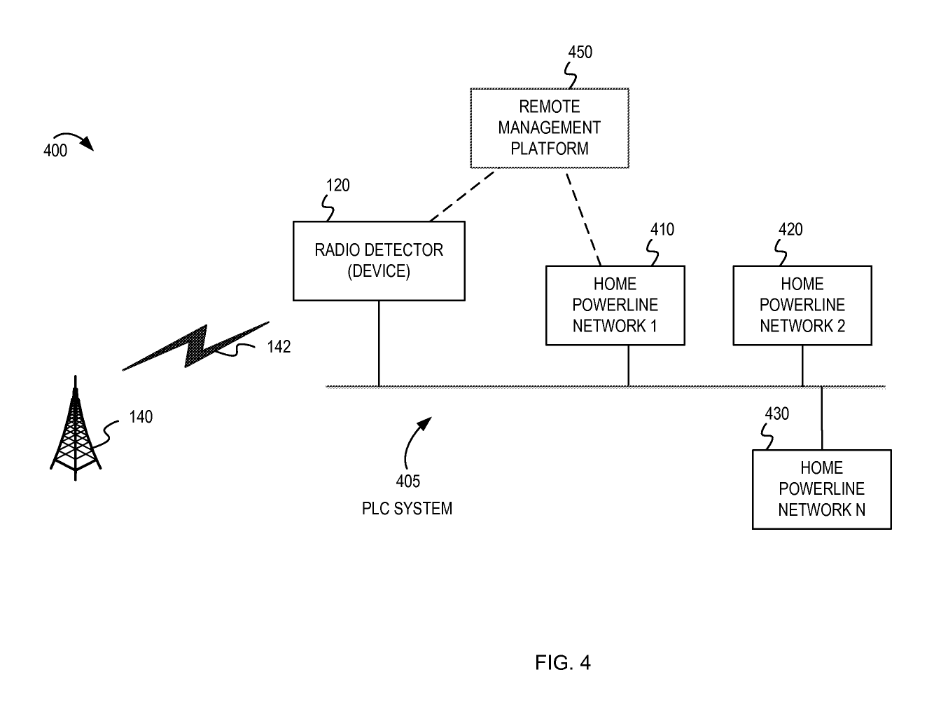

FIG. 4 depicts an example system 400 including a radio detector 120 communicatively coupled via a powerline communications (PLC) system 405 to a plurality of powerline networks. For example, the PLC system 405 may utilize power lines to communicate to a plurality of home powerline networks. FIG. 4 depicts a first home powerline network 410, second home powerline network 420, and other home powerline network(s) 430.

The radio detector 120 may transmit information about the detected radio frequency signal 142 via a variety of messaging techniques. Placement of the radio frequency signal 142 within a neighborhood or city may be flexible in some embodiments. For example, in some embodiments a radio detector 120 may provide radio detection for a household, neighborhood, or region. The radio detector 120 may notify a plurality of devices deployed in the household, neighborhood, or region to reduce power (e.g., “notch”) for the controlled frequencies if an existing safeguarded radio frequency signal 142 is using the controlled frequency. Compliance with regulatory requirements may be made faster, more economical, or more effective by using radio frequency signal 142. For example, an advanced radio detector may be capable of detecting presences of the safeguarded radio frequency signal earlier than devices directly coupled to a powerline network. Furthermore, a broadcast message may be used to inform a plurality of powerline devices regarding the presence of the safeguarded radio frequency signal. Furthermore, legacy devices that are not equipped with the hardware used to detect safeguarded radio frequency signals 142 may be capable of receiving a message from the radio detector 120 and may also comply with the regulatory requirements for controlled frequencies. Legacy devices may already be deployed in powerline networks without a hardware capability to detect the presence of safeguarded radio frequency signals. However, software of the legacy devices may be updated such that the legacy device can receive, interpret, and comply with the message from the radio detector.

In some embodiments, the radio detector may be communicatively coupled to a powerline network and send the information about detected safeguarded signals via a message on the powerline network. In accordance with this disclosure, there are a variety of messages that a radio detector may transmit to cause the first device to reduce power for the controlled frequency due to a presence of the safeguarded radio frequency signal. For example, the radio detector may communicate using one of the following types of messages. In one embodiment, a beacon message broadcast on the communications medium may be modified to include the information about detected controlled frequencies. For example, a beacon message may be sent as a recurring periodic message (e.g., as a periodic configuration message), sometimes communicated from a central controller of a network. To keep the beacon message short, the information about detected controlled frequencies may be included in a limited number of bits or pre-configured mapping of bits to controlled frequencies. In another example, an amplitude map or tone mask message may be communicated to one or more other devices. Information in the amplitude map or tone mask message may indicate the presence of safeguarded radio frequency signals at controlled frequencies. In another embodiment, a MAC management frame or action frame may be used to communicate the information. In another embodiment, an application-layer (e.g., host level) message may be used to communicate the information.

In some embodiments, a plurality of home powerline networks may be managed by a remote management platform 450 communicatively coupled to the radio detector 120 and remote management 450. The radio detector 120 may or may not be collocated in a facility with the remote management platform 450. Examples of the remote management platform 450 may include a centralized management server, a PLC network operator, an upstream communications carrier, or the like. In some implementations, the remote management platform 450 may be capable of monitoring, configuration, or the like. In one embodiment, the remote management platform 450 may receive an indication from the radio detector 120 that the radio detector 120 has detected presence of the safeguarded radio frequency signal. The remote management platform 450 may send a message to the first home powerline network 410 to cause PLC devices of the first home powerline network 410 to limit transmission power for controlled frequencies associated with the safeguarded radio frequency signal. For example, the remote management platform 450 may send one or more unicast messages to various devices, or may send a broadcast message to inform a plurality of devices of the first home powerline network 410 regarding the presence of the safeguarded radio frequency signal.

It should be understood that the remote management platform 450 may be operated by a user of the first home powerline network 410 or may be operated by a centralized administrator that manages a plurality of home powerline networks. Although FIG. 4, depicts the remote management platform 450 communicatively coupled to the first home powerline network 410, it should be understood that in some implementations, the remote management platform 450 may also be communicatively coupled to the second home powerline network 420 or other powerline networks. In one embodiment, the remote management platform 450 may be able to broadcast a system-wide message to a plurality of powerline networks coupled to the PLC system 405.

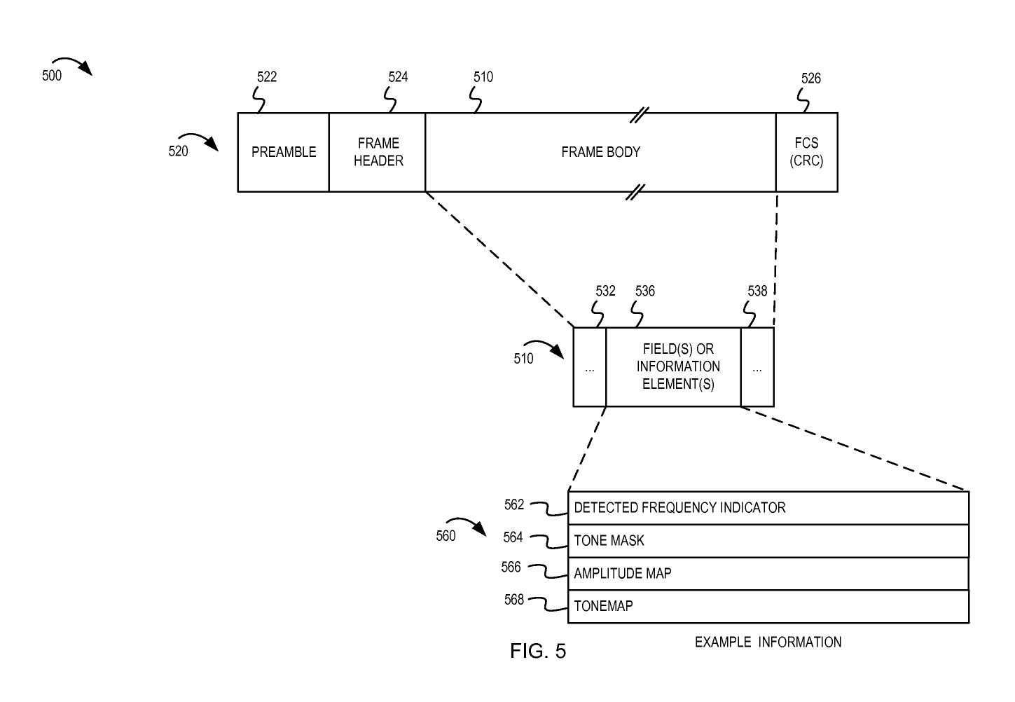

FIG. 5 depicts an example message format 500 for notifying a first device regarding the presence of a safeguarded radio frequency signal at a controlled frequency. Any variety of broadcast or unicast messages may be employed to communicate information about detected safeguarded radio frequency signals at controlled frequencies. Furthermore, fields may be added or omitted to the example message format 500 without departing from the scope of this disclosure.

The example message format 500 includes a protocol data unit (PDU) 520 (sometimes also referred to as a frame or packet in various implementations). The PDU 520 includes a preamble 522, a frame header 524, a frame body 510, and a frame check sequence (FCS) 526 (such as a cyclic redundancy check, CRC). In one example, the frame header 524 may include a source address and destination address associated with the message. In another example, the frame header 524 may omit the destination address or use a generic destination address, such as a broadcast address. The frame header 524 may include information that identifies the contents of the frame body 510.

The frame body 510 may be organized with a message format and may include a variety of fields or information elements 532, 536, 538. In one example, the frame body 510 includes a protocol identifier (not shown) that indicates the message includes information about a detected safeguarded radio frequency signal. Various example fields or information elements 560 are described. One or more of these may be included in an example message format. In one embodiment, the example fields or information elements 560 may include a detected frequency indicator 562. In one example, the detected frequency indicator 562 may comprise a bitmap that identifies predefined controlled frequencies. Alternatively, the detected frequency indicator 562 may include frequency information regarding the detected safeguarded radio frequency signal.

In another embodiment, the example fields or information elements 560 may include a tone mask 564. The tone mask 564 may indicate carriers which should not be used by the first device. In another embodiment, the example fields or information elements 560 may include an amplitude map 566. The amplitude map 566 may indicate power levels for a plurality of carriers in a multi-carrier system. The amplitude map 566 may indicate a lower power level (or “zero”) for carriers that are detected in the safeguarded radio frequency signal. In another embodiment, the example fields or information elements 560 may include a tone map 568. The tone map 568 may define modulation and coding scheme or error coding parameters for a plurality of carriers. A value could be used in the tone map to indicate that the carrier is associated with a detected safeguarded radio frequency signal.

As there may be different capabilities for particular radio detectors, the message generated by the radio detector may have different levels of sophistication. In one embodiment, a message may indicate detection of a safeguarded radio frequency signal without identifying a particular controlled frequency. For example, a simple radio detector capable of detecting presence of a safeguarded radio frequency signal may send a simple message causing all controlled frequencies to be notched. In another embodiment, a message may indicate particular controlled frequencies that should be notched. For example, a more advanced radio detector may detect and identify a particular controlled frequency and send a message that identifies that controlled frequency (or associated controlled frequency band).

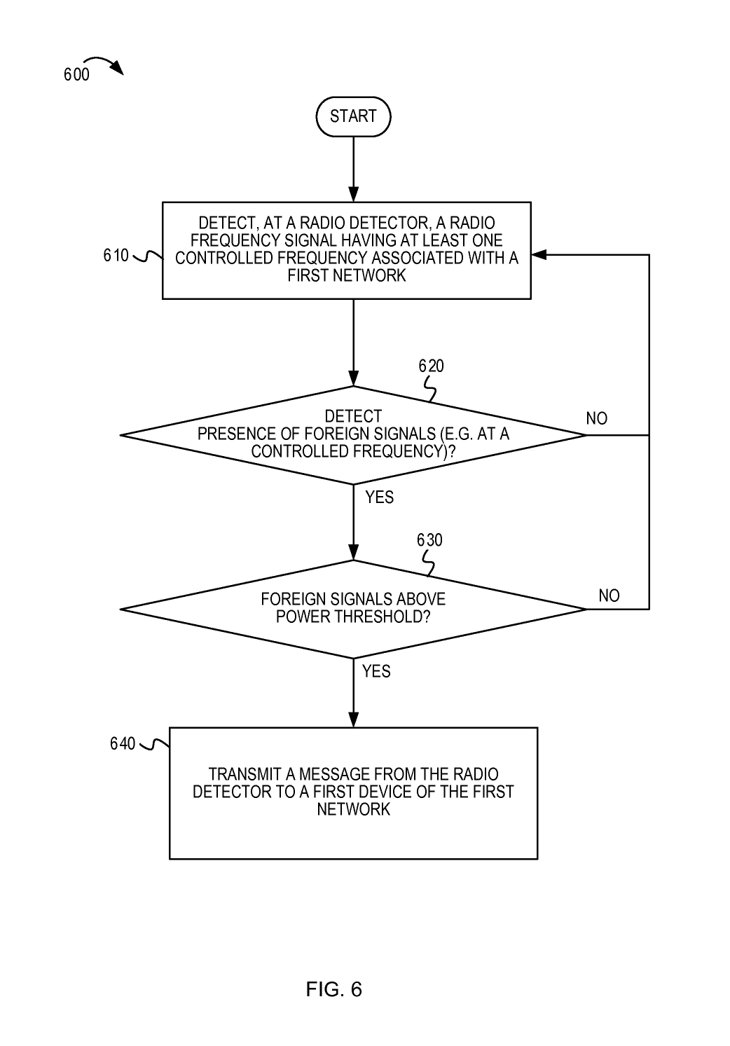

FIG. 6 depicts example operations 600 of a radio detector in accordance with an embodiment of this disclosure. At block 610, a radio detector may detect a safeguarded radio frequency signal having at least one controlled frequency associated with a first network. At decision 620, the radio detector may determine whether the presence of safeguarded radio frequency signals is detected. In some embodiments, the radio detector may limit detection to a list of predefined controlled frequencies. In other embodiments, the detector may search for the presence of safeguarded radio frequency signals within a frequency band associated with the first network. If the presence of safeguarded radio frequency signals is not detected, the flow diagram returns to block 610. If the presence of safeguarded radio frequency signals is detected, the flow diagram continues to decision 630.

At decision 630, the radio detector may determine whether the safeguarded radio frequency signals are above a power threshold. In some embodiments, the power threshold may be a predefined or configurable value. In other embodiments, the power threshold may be based on detected noise floor for the radio environment. If the safeguarded radio frequency signals are not above the power threshold, the flow diagram returns to block 610. If the safeguarded radio frequency signals are above the power threshold, the flow diagram continues to block 640.

At block 640, the radio detector may transmit a message from the radio detector to a first device of the first network. The message may inform the first device regarding the detected safeguarded radio frequency signals. The message may cause the first device to reduce power for the controlled frequency due to a presence of the safeguarded radio frequency signal.

It should be understood that FIGS. 1-6 and the operations described herein are examples meant to aid in understanding embodiments and should not be used to limit embodiments or limit scope of the claims. Embodiments may perform additional operations, fewer operations, operations in parallel or in a different order, and some operations differently.

Embodiments may take the form of an entirely hardware embodiment, a software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein.

Any combination of one or more non-transitory computer readable medium(s) may be utilized. Non-transitory computer-readable media comprise all computer-readable media, with the sole exception being a transitory, propagating signal. The non-transitory computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code embodied on a computer readable medium for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described with reference to flowchart illustrations and/or block diagrams of methods, apparatus (systems) and computer program products according to embodiments of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

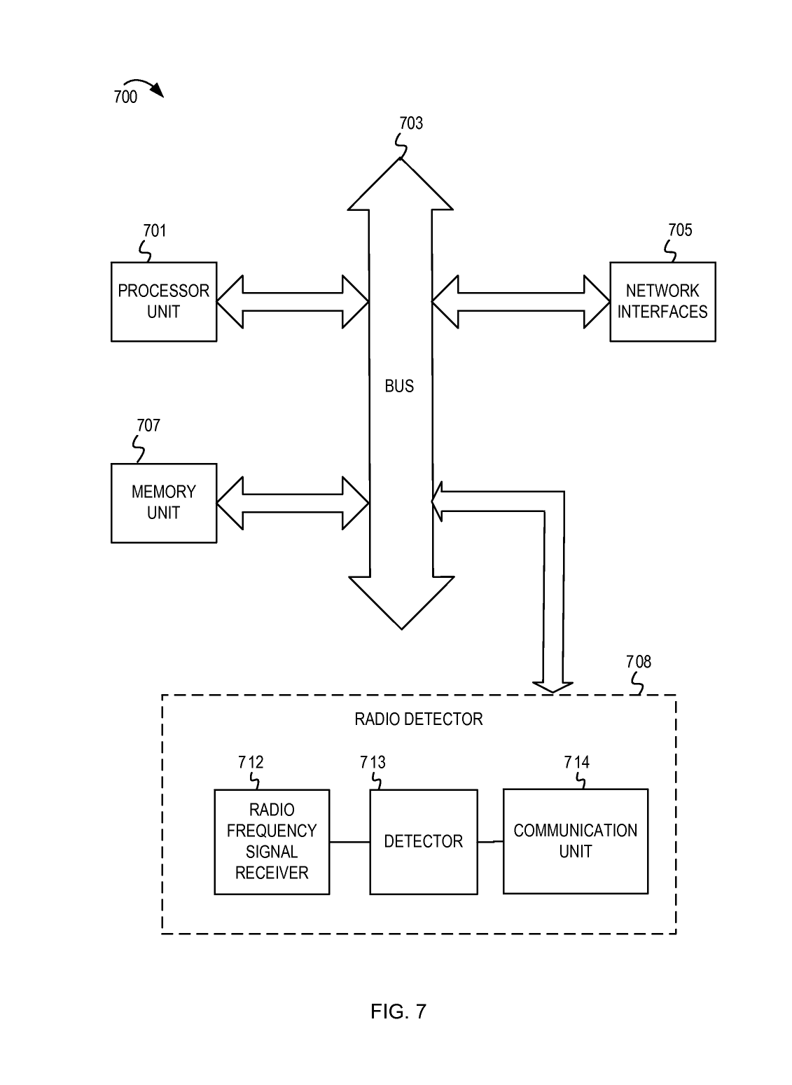

FIG. 7 depicts an electronic device 700 suitable for implementing various embodiments of this disclosure. A computer system includes a processor unit 701 (possibly including multiple processors, multiple cores, multiple nodes, and/or implementing multi-threading, etc.). The computer system includes memory unit 707. The memory unit 707 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 703 (e.g., PCI, ISA, PCI-Express, HyperTransport®, InfiniBand®, NuBus, etc.), a network interface 705 (e.g., an ATM interface, an Ethernet interface, a Frame Relay interface, SONET interface, wireless interface, etc.), and a memory unit 707. The memory unit 707 embodies functionality to implement embodiments described above. The memory unit 707 may include one or more functionalities that facilitate detecting a radio frequency signal having at least one controlled frequency associated with a first network. Any one of these functionalities may be partially (or entirely) implemented in hardware and/or on the processor unit 701. For example, the functionality may be implemented with an application specific integrated circuit, in logic implemented in the processor unit 701, in a co-processor on a peripheral device or card, etc. Further, realizations may include fewer or additional components not illustrated in FIG. 7 (e.g., video cards, audio cards, additional network interfaces, peripheral devices, etc.). The processor unit 701, the memory unit 707, and the network interface 705 are coupled to the bus 703. Although illustrated as being coupled to the bus 703, the memory unit 707 may be coupled to the processor unit 701.

The electronic device 700 may include a radio frequency signal receiver 712, a detector 713, and a communication unit 714. In some embodiments, the radio frequency signal receiver 712, detector 713, and communication unit 714 may be part of a radio detector 708 of the electronic device 700. In other embodiments, the processor unit 701 and memory unit 707 of the electronic device 700 may be part of the radio detector 708. The radio frequency signal receiver 712 may be configured to receive and detect a safeguarded radio frequency signal having at least one controlled frequency associated with a first network. The communication unit 714 may be configured to transmit a message to a first device of the first network to cause the first device to reduce power for the controlled frequency due to a presence of the safeguarded radio frequency signal. The detector 713 may be configured to compare signal strength of the safeguarded radio frequency signal with a threshold to determine whether the safeguarded radio frequency signal includes at least one controlled frequency associated with the first network. In some embodiments, an antenna (not shown) may be part of the radio detector 708 and may facilitate receiving the radio frequency signal.

While the embodiments are described with reference to various implementations and exploitations, it will be understood that these embodiments are illustrative and that the scope of the present disclosure is not limited to them. In general, techniques for detecting the presence of a radio frequency signal having at least one controlled frequency and transmitting a message regarding the presence of the radio frequency signal as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the present disclosure. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the present disclosure.

What is claimed is:

1. A method comprising:
detecting, at a radio detector, a safeguarded radio frequency signal having at least one controlled frequency associated with a first network; and
transmitting a message from the radio detector to a first device of the first network to cause the first device to reduce power for the controlled frequency due to a presence of the safeguarded radio frequency signal.

2. The method of claim 1, wherein transmitting the message comprises transmitting a broadcast message via the first network to cause a plurality of devices to reduce power or refrain from transmitting on the controlled frequency.

3. The method of claim 2, wherein the broadcast message comprises a configuration message of the first network.

4. The method of claim 1, wherein the message comprises one or more of a management frame, tone map message, an amplitude map message, a beacon message, a unicast host message, or a tone mask message.

5. The method of claim 1, wherein detecting the safeguarded radio frequency signal includes:
scanning for the presence of the safeguarded radio frequency signal from a list of controlled frequencies associated with the first network.

6. The method of claim 1, wherein the safeguarded radio frequency signal comprises a wireless broadcast signal and the first network comprises a wired network.

7. The method of claim 1, wherein the radio detector is configured to detect shortwave radio frequency signals at controlled frequencies associated with a powerline network.

8. The method of claim 1, wherein the radio detector is communicatively coupled to a host device and the host device is communicatively coupled to the first network, the radio detector configured to transmit the message to the first device via the host device.

9. The method of claim 1, wherein the radio detector is communicatively coupled to a powerline communications system that provides communications to a plurality of powerline networks including the first network.

10. The method of claim 9, wherein transmitting the message comprises transmitting messages from the radio detector via the powerline communications system to the plurality of powerline networks.

11. An apparatus comprising:
a radio frequency signal receiver configured to receive and detect a safeguarded radio frequency signal having at least one controlled frequency associated with a first network; and
a communication unit configured to transmit a message to a first device of the first network to cause the first device to reduce power for the controlled frequency due to a presence of the safeguarded radio frequency signal.

12. The apparatus of claim 11, wherein the communication unit is configured to transmit a broadcast message via the first network to cause a plurality of devices to refrain from transmitting using the controlled frequency.

13. The apparatus of claim 11, wherein the message comprises one of a management frame, tone map message, an amplitude map message, a beacon message, a unicast host message, or a tone mask message.

14. The apparatus of claim 11, wherein the radio frequency signal receiver is configured to scan for the presence of the safeguarded radio frequency signal from a list of controlled frequencies associated with the first network.

15. The apparatus of claim 11, further comprising:
a host device interface configured to communicatively couple the apparatus to a host device, wherein the communication unit is configured to transmit the message to the first device via the host device interface and the host device.

16. The apparatus of claim 11, wherein the radio frequency signal receiver comprises:
an antenna for receiving the safeguarded radio frequency signal; and
a detector configured to compare a signal strength of the safeguarded radio frequency signal with a threshold to determine whether the safeguarded radio frequency signal includes at least one controlled frequency associated with the first network.

17. A non-transitory computer readable medium storing instructions which, when executed by one or more processors of a device, cause the device to:
detect a safeguarded radio frequency signal having at least one controlled frequency associated with a first network; and
transmit a message to a first device of the first network to cause the first device to reduce power for the controlled frequency due to a presence of the safeguarded radio frequency signal.

18. The non-transitory computer readable medium of claim 17, wherein transmitting the message comprises transmitting a broadcast message via the first network to cause a plurality of devices to reduce power for the controlled frequency.

19. The non-transitory computer readable medium of claim 17, wherein the message comprises one of a management frame, tone map message, an amplitude map message, a beacon message, a unicast host message, or a tone mask message.
